(19) United States
(12) Patent Application Publication
(10) Pub. No.: US 2011/0287191 A1
(43) Pub. Date: Nov. 24, 2011

(54) PRODUCTION METHOD OF MULTILAYER PIECES COMPRISING INCLINED HOLES AND RESISTANT TO HIGH THERMAL STRESSES, AND USE OF THE METHOD FOR REPAIRING PIECES

(75) Inventors: Antoine MARTIN, Cherisy (FR); Thac-Si DO, Vaureal (FR)

(73) Assignee: C.R.M.A., Elancourt (FR)

(21) Appl. No.: 12/782,233

(22) Filed: May 18, 2010

(51) Int. Cl. B05D 3/06; B23K 31/02

(52) U.S. Cl. 427/554; 228/119

(57) ABSTRACT

One or more embodiments relate to a production method of multilayer pieces comprising holes having inclined axes and the pieces being resistant to high temperatures and having a bond sub-layer and a thermal barrier coating layer (TBC) comprising depositing the bond sub-layer on the substrate of the piece, depositing the TBC layer, depositing by plasma spraying of a variable or defined composition gradient layer between the TBC layer and the bond sub-layer after the depositing step of the bond sub-layer and drilling the holes via laser beam. A method for repairing a defective piece via the method is described.

### FIELD

One of more embodiments of the present invention relate to the field of combustion chambers or industrial turbines, in particular the production of piercings or holes in a piece made of multilayer materials such as a metallic substrate covered in ceramic.

### BACKGROUND

It is known from patent application FR 2 909 297 to use laser drilling techniques of cooling holes for hot pieces required to resist substantial temperatures, such as the walls of a combustion chamber in a turbojet engine or industrial turbine blades. These hot pieces are protected by a coating layer creating a thermal barrier often made of ceramic, which is bonded onto the substrate of the hot piece by a bond sub-layer. The thermal barrier coating (TBC) is also protected by a film of air produced by the cooling holes.

It is also known from patent application US 2008/0241560 to deposit via plasma diffusion a layer of ceramic powder mixed with powder of an intermetallic compound of nickel aluminide (NiAl) onto a substrate made of nickel-based superalloy to boost the shelf life of the thermal barrier or the thickness of the layer.

It is also known from patent application EP 0 799 904 to deposit, by physical deposit in vaporous phase under electron beam (EB-PVD or Electron Beam Physical Vapor Deposition), of a layer whereof the different compounds constituted by ceramic and a mix of oxides of aluminium, chromium, nickel, yttrium and zirconium are distributed throughout the thickness according to a gradient to improve layer-bonding reliability (page 4, 3^{rd} example).

Production technology for combustion chambers is evolving. For a long time, the walls of combustion chambers comprised tiered panels (FIG. 4) separated by zones comprising cooling holes of a diameter on the order of 1.2 mm to a few millimetres. A film of air circulated through these cooling holes, creating a protective screen. Now, this type of wall is replaced by one or more panels (FIG. 5) having a large number of cooling holes of minimal diameter on the order of 0.3 mm to 0.8 mm. This novel technique for walls produces a much more homogeneous film of air which better protects the thermal barrier coating, enabling a considerably increased operating temperature of the combustion chamber. The axis of the holes relative to the surface of the hot piece is determined according to the configuration of the required film of air, meaning that a certain number of holes will have an axis inclined relative to the surface.

Different techniques enable hole drilling, such as discharging technique and laser drilling technique.

The discharging technique consists of thermal spraying of the bond sub-layer on the substrate of the hot piece, then laser drilling of the substrate and of the sub-layer. Plasma spraying of a first layer of thermal barrier TBC is then applied, followed by discharging via an abrasive method. A second layer of TBC is then applied, to be followed by a second discharging procedure via an abrasive method. This technique utilises a long and scarcely reliable method.

The laser drilling technique per se consists of laser beam drilling of the substrate, of the bond sub-layer and of the TBC assembly, effectively reducing the steps of the applied method. However, interaction between the highly energetic laser and the substrate coated with the bond sub-layer and TBC causes laser detonation, creating a shockwave. This shockwave associated with differential dilatation of the materials constituting the substrate, the bond sub-layer and the TBC (the physical-chemical properties of which are different), combined with the phenomena of tension and resolidification of the liquid layers, causes delamination or even peeling of the TBC layer in the event of very low incidence angles of the laser beam, under 25°. Delaminating of each hole can result in peeling by plaque immediately or during operation of the combustion chamber. In the first case, the piece cannot be used. In the second case, the shelf life of the piece is reduced, creating a major risk for the turbojet engine comprising the combustion chamber.

### SUMMARY

An aim of one or more embodiments of the present invention is to rectify these disadvantages by proposing a production method for pieces comprising inclined holes, and required to resist high temperatures.

In at least some embodiments, this aim is achieved by a production method for multilayer pieces comprising holes whereof the axes are inclined and required to resist high thermal stresses having a bond sub-layer and a thermal barrier coating layer (TBC) comprising at least the following steps:
a depositing step of the bond sub-layer on the substrate of the piece;
a depositing step of the TBC layer.

The method also comprises the following steps:
a depositing step of a variable or defined composition gradient layer between two materials by plasma spraying after the depositing step of the bond sub-layer;
a drilling step of holes via laser beam.

According to another particular feature, the variable composition gradient layer between two materials shifts progressively from a composition of 100% of material of bond sub-layer and 0% of TBC material in the zone near the bond sub-layer to a composition of 0% of bond sub-layer material and 100% of TBC material in the zone near the TBC layer.

According to another particular feature, the defined composition gradient layer is a homogeneous mix of the materials constituting the bond sub-layer and the TBC layer and is deposited between the bond sub-layer and the TBC layer.

According to another particular feature, the mass proportion of material of bond sub-layer is preferably from 50% to 75% relative to the total mass of the materials of the bond sub-layer and TBC layer forming the composition gradient layer.

According to another particular feature, the TBC layer is made of ceramic.

According to another particular feature, the bond sub-layer is made of alloy of NiCrAlY type, for a substrate based on cobalt or nickel or chromium.

According to another particular feature, the substrate of the piece is made of alloy based on at least cobalt and chromium.

According to another particular feature, the composition gradient layer has a thickness of between 0.15 mm and 0.30 mm.

According to another particular feature, the bond sub-layer has a thickness of between 0.08 mm and 0.25 mm.

According to another particular feature, the TBC layer has a thickness of between 0.20 mm and 0.60 mm.

In at least some embodiments, another aim is attained by proposing use of the production method for multilayer pieces comprising holes whereof the axes are inclined with low incidence and required to resist high temperatures, having a bond sub-layer, a variable or defined composition gradient layer and a layer of ceramic material forming TBC for repairing a combustion chamber of an engine, characterised in that it comprises at least the following steps:
a cutout step of part of the defective piece;
a welding step at the site of part of the defective piece of a metallic substrate piece based on cobalt and chromium;
a depositing step of a material forming the bond sub-layer on the substrate of the piece;
a depositing step by plasma spraying of a variable or defined composition gradient layer between the two materials;
a depositing step of the layer of material forming TBC;
a drilling step of holes via laser beam.

According to another particular feature, such use also comprises a verification step of the efficacy of a film of air generated by an air flow passing through the piece via the holes.

### BRIEF DESCRIPTION OF THE DRAWINGS

Other particular features and advantages of the present invention will emerge more clearly from the following description, given in reference to the attached figures, in which:

FIG. 1 is an illustration of a section of a piece of the multilayer piece according to axes of holes without the composition gradient layer;

FIG. 2 is an illustration of a section of a piece of the multilayer piece according to axes of holes with the composition gradient layer;

FIG. 3 is an illustration of a schematic section of a turbojet engine having the piece according to an embodiment;

FIG. 4 is an illustration of a transversal section of the piece forming the walls of the combustion chamber constituted by tiered panels;

FIG. 5 is an illustration of a transversal section of the piece forming the walls of the combustion chamber constituted by one or more panels having a very large number of cooling holes.

### DETAILED DESCRIPTION OF THE DRAWINGS

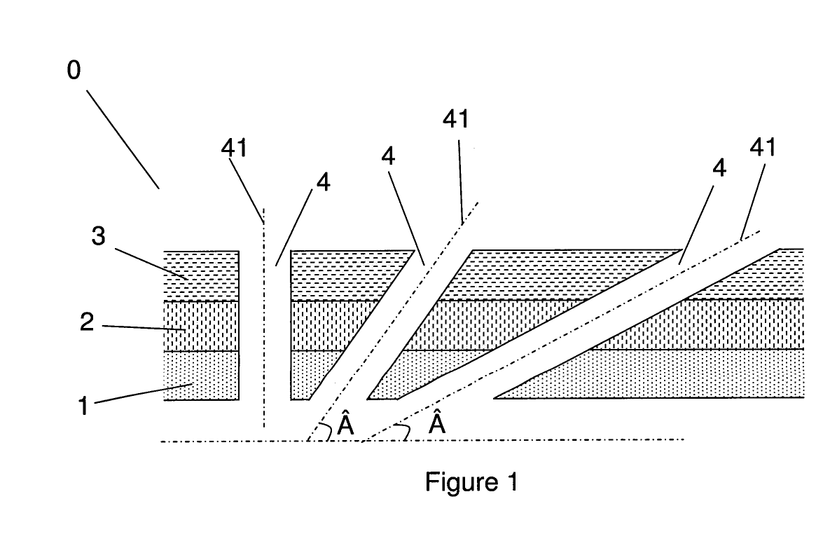

In the present description, reference will be made to FIGS. 1, 2, 3, 4 and 5.

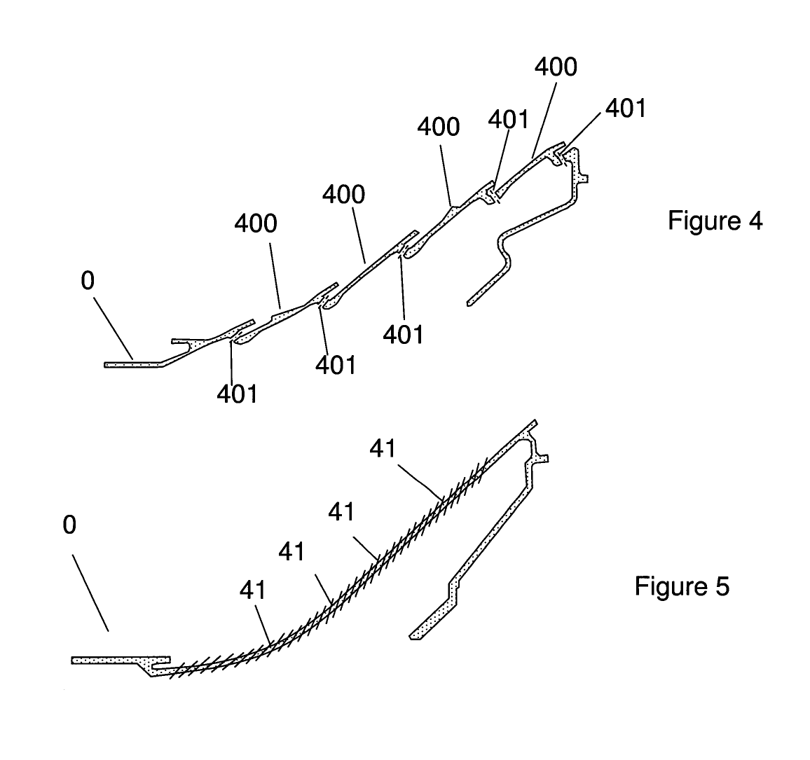

At least one embodiment of the present invention relates to a production method of pieces, as illustrated in FIG. 5, comprising holes (4) whereof the axes are inclined with low incidence Â in, in a non-limiting manner, a range from 15° to 25°, and required to resist thermal stresses or high temperatures. In at least some embodiments, this type of piece is the liner (0) of a combustion chamber of a turbojet engine (100). But it must be understood that the method is applicable in other areas such as the blades of industrial turbines. FIG. 4 illustrates the piece such as produced in earlier technology where the combustion chamber walls were constituted by tiered panels (400) separated by zones comprising cooling holes (401).

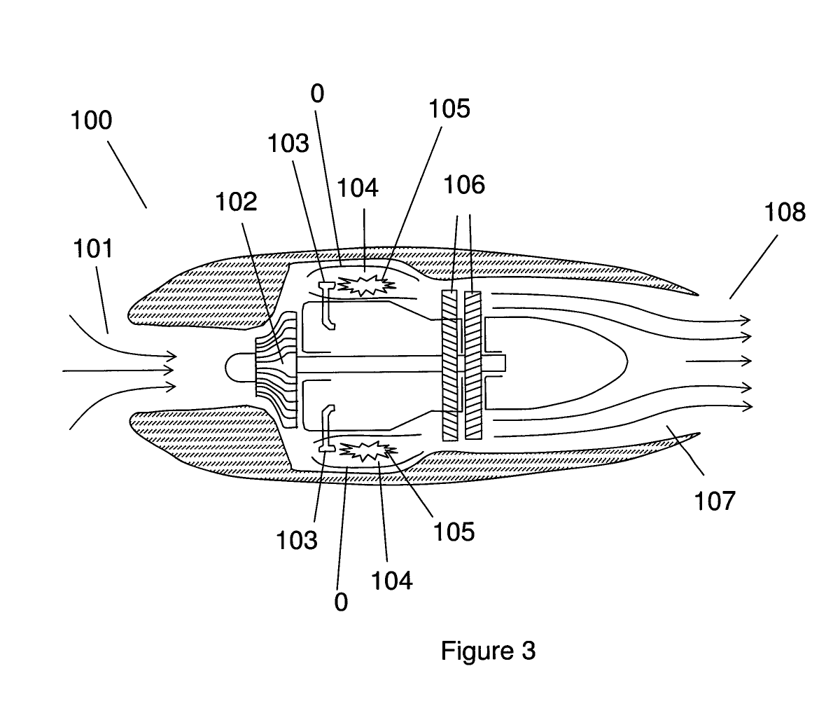

FIG. 3 illustrates a schematic figure of a section of a turbojet engine. The thrust produced by the turbojet engine (100) is generated by acceleration of the air flow between the intake (101) and the outlet (108) at a jet pipe (107). Acceleration is gained by combustion (105) in a combustion chamber (104) of a fuel, for example kerosene, introduced via injectors (103) with the oxygen of the air entering the turbojet engine. Part of the energy produced is recovered by a turbine (106) using a compressor (102) which compresses the air at the intake of the turbojet engine (100). The temperatures reached at the outlet of the combustion chamber (104) can rise to 2,000° C.

The combustion chamber (104) is delimited by a piece (0) called a liner, the walls of which are for example an alloy based on cobalt and chromium. In a non-limiting manner, the alloy is made up of at least 39% cobalt, 22% chromium, 22% nickel, tungsten and iron.

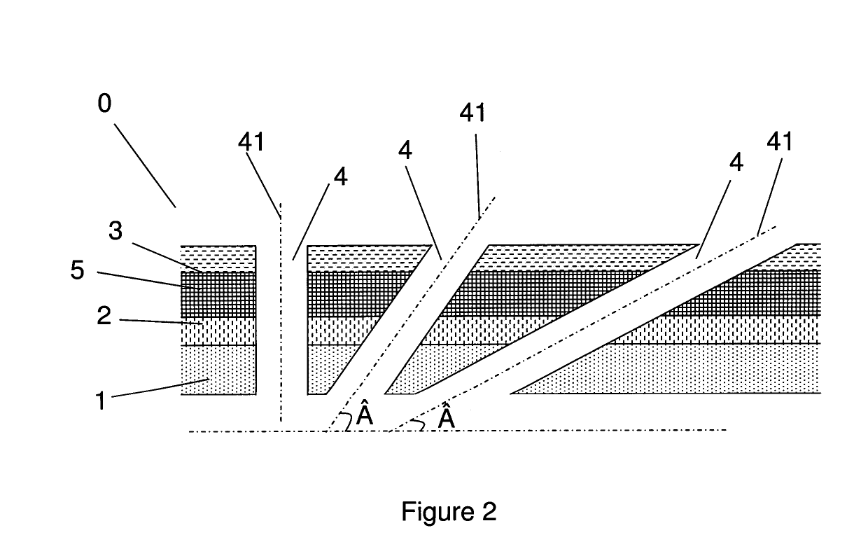

The walls of the combustion chamber (104) form a substrate (1) on which are deposited at least one bond sub-layer (2) bonding on the walls a thermal barrier coating layer (3) (TBC) which protects the walls from heat generated by combustion and oxidation (FIG. 1 and FIG. 2).

The bond sub-layer (2) is made for example of material of NiCrAlY alloy type (nickel, chromium, aluminium, yttrium) for a substrate based on cobalt and/or nickel and/or chromium. For example, for a nickel-based substrate, the alloy can be composed of 22% chromium, 10% aluminium and 1% yttrium.

The TBC layer is made of ceramic material, for example, zirconium oxide (ZrO₂).

Depositing the different layers is done according to the following procedure.

In a first step, the bond sub-layer (2) is deposited on the substrate (1), for example, by plasma spraying. The plasma spraying is performed by plasma torch which hot-projects particles injected into the torch and which are to be deposited. These soft particles or melted droplets are crushed on the surface to be treated.

In a following step, a composition gradient layer (5) between two materials is deposited by plasma spraying.

According to one configuration, the composition gradient layer (5) shifts progressively from a composition of 100% of bond sub-layer (2) material and 0% of TBC material in the zone near the bond sub-layer (2) to a composition of 0% of bond sub-layer (2) material and 100% of TBC material in the zone near the TBC layer (3). The variable gradient layer composition (5) between the two materials is deposited by plasma torch into which is injected 100% of a quantity of particles of the bond sub-layer (2) material and 0% of a quantity of particles of the TBC material at the start of plasma spraying. Next, the quantity of particles of material of the bond sub-layer (2) is progressively decreased by progressively increasing the quantity of particles of TBC material until 0% of a quantity of particles of material of the bond sub-layer (2) and 100% of quantity of particles of TBC material are reached. The quantities of particles to be projected can be adjusted using a plasma torch control device. A program is executed by a processor of the control device, which adjusts the composition and thickness of the composition gradient layer (5).

According to another configuration, the defined composition gradient layer (5) is a homogeneous mixture of material constituting the bond sub-layer (2) and the TBC layer (3). Particles of each material are mixed by means of a mixer to produce a homogeneous mix of particles. In a non-limiting manner, the mass proportion of particles of bond sub-layer (2) material is preferably from 50% to 75% relative to the total mass of the particles forming the composition gradient layer (5). This layer is deposited between the bond sub-layer (2) and the TBC layer (3).

In a following step, a TBC layer (3) is deposited via plasma spraying, for example.

In a non-limiting manner, the composition gradient layer (5) has a thickness in a range from 0.15 mm to 0.30 mm, preferably from 0.20 mm to 0.25 mm.

In a non-limiting manner, the bond sub-layer (2) has a thickness in a range from 0.08 mm to 0.25 mm, preferably from 0.10 mm to 0.15 mm.

In a non-limiting manner, the TBC layer (3) has a thickness of in a range from 0.20 mm to 0.60 mm, preferably from 0.25 mm to 0.55 mm.

In a following step, the holes (4) are pierced by at least one laser beam according to an axis (41) calculated such that the film of air is optimised for protection of the TBC layer (3). The laser beam is directed according to a program executed by a processor, which determines the position of the laser beam as a function of the position of each hole (4) and of the angle to be made by the axis (41) of each hole (4) relative to the surface of the piece (0). In a non-limiting manner, each hole has a diameter of the order of 0.3 mm to 0.8 mm, preferably of the order of 0.4 mm.

In a non-limiting manner, a hole (4) is made in two steps. A first percussion step which consists of utilising the fixed laser beam with an incidence A comprised for example in a range from 15° to 25° in a pulsed mode so as to penetrate the thickness of the piece (0) and protective layers (2, 3, 5). A second trepanning step consists of cutting out the hole (4) by moving the laser beam in a circle.

In at least some embodiments, the production method of a piece (0) is used to repair a combustion chamber of an engine which might have a defective piece.

In a first step, the defective piece is cut out, for example, by laser or by blowpipe.

In a following step, a piece of material forming the substrate, based for example on cobalt, chromium and nickel, is welded at the site of the cutout defective piece. This piece then undergoes the production method of a piece as previously described.

After this method, a verification step of the efficacy of the film of air is carried out. An air flow similar to the air flow effective during functioning of the turbojet engine is generated. It is therefore possible to verify the efficacy of the film of air generated by the air flow passing through the piece via the holes (4).

It must be evident for specialists that the present invention allows embodiments in numerous other specific forms without departing from the field of application of the invention as claimed. Consequently, the present embodiments must be considered by way of illustration, but can be modified in the field defined by the scope of the attached claims, and the invention must not be limited to the details given hereinabove.

1. A production method of multilayer pieces comprising holes having inclined axes and the pieces being resistant to high thermal stresses and having a bond sub-layer and a thermal barrier coating layer (TBC), comprising at least the following steps:
depositing the bond sub-layer on substrate of the piece;
depositing the TBC layer;
depositing a composition gradient layer between two materials by plasma spraying after depositing the bond sub-layer; and
drilling the holes via laser beam.

2. The method as claimed in claim 1, wherein the depositing of the composition gradient layer between two materials shifts progressively from a composition of 100% of bond sub-layer material and 0% of TBC material in the zone near the bond sub-layer to a composition of 0% of bond sub-layer material and 100% of TBC material in the zone near the TBC layer.

3. The method as claimed in claim 1, wherein the depositing of the composition gradient layer is a homogeneous mixture of the materials constituting the bond sub-layer and the TBC layer and is deposited between the bond sub-layer and the TBC layer.

4. The method as claimed in claim 3, wherein the proportion in material mass of the depositing of the bond sub-layer is preferably from 50% to 75% relative to the total mass of the materials of the bond sub-layer and TBC layer forming the composition gradient layer.

5. The method as claimed in claim 1, wherein the TBC layer is made of ceramic.

6. The method as claimed in claim 1, wherein the bond sub-layer is made of alloy of NiCrAlY type, for a substrate based on at least cobalt or nickel or chromium.

7. The method as claimed in claim 1, wherein the substrate of the piece is made of alloy based on at least cobalt and chromium.

8. The method as claimed in claim 1, wherein the composition gradient layer has a thickness of in a range from 0.15 mm to 0.30 mm.

9. The method as claimed in claim 1, wherein the bond sub-layer has a thickness of in a range from 0.08 mm to 0.25 mm.

10. The method as claimed in claim 1, wherein the TBC layer has a thickness of in a range from 0.20 mm to 0.60 mm.

11. A production method of pieces comprising holes having inclined axes with low incidence and the pieces being resistant to high thermal stresses and having a bond sub-layer, a variable or defined composition gradient layer and a layer of ceramic material forming TBC for repairing a combustion chamber of an engine, the method comprises:
removing part of a defective piece of the chamber;
welding a piece of metallic substrate based on cobalt and chromium at the site of the part of the defective piece;
depositing material forming the bond sub-layer on the substrate of the piece;
depositing a defined or variable composition gradient layer between the two materials via plasma spraying;
depositing the layer of material forming TBC; and
drilling the holes via laser beam.

12. The method as claimed in claim 11, further comprising verifying the efficacy of a film of air generated by an air flow passing through the piece via the holes.

13. The method as claimed in claim 1, wherein depositing a composition gradient comprises depositing a variable composition gradient.

14. The method as claimed in claim 1, wherein depositing a composition gradient comprises depositing a defined composition gradient.
